(19) United States
(12) Patent Application Publication
(10) Pub. No.: US 2005/0262055 A1
(43) Pub. Date: Nov. 24, 2005

(54) Enforcing message ordering

(75) Inventor: William T. Newport, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/849,581

(22) Filed: May 20, 2004

(51) Int. Cl. G06F 7/00

(52) U.S. Cl. 707/3

(57) ABSTRACT

A method, apparatus, system, and signal-bearing medium that in an embodiment enforce ordering of messages sent from a queue to clients. If a total order indicator is on for a queue associated with a get message request, the next message is sent from the queue to the client if the queue does not have an associated in-doubt transaction. An in-doubt transaction may be a transaction for which the client has not received a commit request. In another embodiment, an authorized client is selected and messages are only sent from the queue to the authorized client.

### FIELD

An embodiment of the invention generally relates to computers. In particular, an embodiment of the invention generally relates to enforcing message ordering in a distributed computing environment.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware (such as semiconductors, integrated circuits, programmable logic devices, programmable gate arrays, and circuit boards) and software, also known as computer programs.

Years ago, computers were isolated devices that did not communicate with each other. But, today computers are often connected in networks, such as the Internet or World Wide Web, and a user at one computer, often called a client, may wish to access information at multiple other computers, often called servers, via a network. Accessing and using information from multiple computers is often called distributed computing.

One of the challenges of distributed computing is the propagation of messages from one computer system to another. In many distributed computing systems connected via networks, to maintain data consistency it is critical that each message be delivered only once and in order to its intended destination site. For example, in a distributed database system, messages that are propagated to a destination site often specify updates that must be made to data that reside at the destination site. The updates are performed as a “transaction” at the destination site. Frequently, such transactions are part of larger distributed transactions that involve many sites. If the transactions are not delivered once and in order, problems with data consistency may occur, e.g., if database insert and update operations are out of order, the update attempts to modify a record that is not yet present.

To maintain data consistency, distributed database systems require that (1) all changes made by a distributed transaction must either be “committed” or, in the event of an error, “rolled back”; and (2) transaction messages are to be processed in the order in which they are received. When a transaction is committed, all of the changes to data specified by the transaction are made permanent. On the other hand, when a transaction is rolled back, all of the changes to data specified by the transaction already made are retracted or undone, as if the changes to the data were never made.

One approach for ensuring data consistency in a distributed system is to use a two-phase commit sequence to propagate messages between the distributed computer systems. The two-phase commit sequence involves two phases: the prepare phase and the commit phase. In the prepare phase, the transaction is prepared at the destination site. When a transaction is prepared at a destination site, the database is put into such a state that it is guaranteed that modifications specified by the transaction to the database data can be committed. Once the destination site is prepared, it is said to be in an in-doubt state. In this context, an in-doubt state is a state in which the destination site has obtained the necessary resources to commit the changes for a particular transaction, but has not done so because a commit request has not been received from the source site. Thus, the destination site is in-doubt as to whether the changes for the particular transaction will go forward and be committed or instead, be required to be rolled back. After the destination site is prepared, the destination site sends a prepared message to the source site, so that the commit phase may begin.

In the commit phase, the source site communicates with the destination site to coordinate either the committing or rollback of the transaction. Specifically, the source site either receives prepared messages from all of the participants in the distributed transaction, or determines that at least one of the participants has failed to prepare. The source site then sends a message to the destination site to indicate whether the modifications made at the destination site as part of the distributed transaction should be committed or rolled back. If the source site sends a commit message to the destination site, the destination site commits the changes specified by the transaction and returns a message to the source site to acknowledge the committing of the transaction.

Alternatively, if the source site sends a rollback message to the destination site, the destination site rolls back all of the changes specified by the distributed transaction and returns a message to the source site to acknowledge the rolling back of the transaction. Thus, the two-phase commit protocol may be used to attempt to ensure that the messages are propagated exactly once and in order. The two-phase commit protocol further ensures that the effects of a distributed transaction are atomic, i.e., either all the effects of the transaction persist or none persist, whether or not failures occur.

It is important for the efficiency of some of these data communications to be able to transfer the messages of the transactions in a batch of several messages. Such batching of messages speeds message throughput and can reduce network communication traffic by limiting control communications (such as sender and receiver location information and confirmations of receipt and commit processing) to one set of communication flows per batch instead of one set per message. In transaction processing systems, committing updates on completion of a transaction involves a relatively high processing overhead, so only committing at the end of a batch of transactional updates can significantly improve system efficiency.

Some distributed systems use a message engine to facilitate the transfer of messages between the source and destination sites. A message engine typically has multiple attached clients. The clients communicate with the message engine using a protocol. As part of the protocol, the clients send requests to the message engine and the message engine responds by sending one or more messages at a time to the client. The client then processes each message and sends, e.g., RPCs (Remote Procedure Calls) to a server to begin/commit/rollback transactions associated with each message. Although a message engine may claim that it enforces FIFO (First In First Out) ordering of messages, the message engine may have problems in maintaining ordering when multiple destination sites exist and when rollbacks and failures with in-doubt transactions occur.

One problem can occur when batch messages are used for efficiency (as previously described above). For example, if the client receives message 1, message 2, message 3, and message 4 in a batch and then processes message 1, but on message 2 rolls back the transaction, then the client typically informs the message engine immediately, but then provides message 3 and message 4 to the server. When the client then requests more messages from the message engine, the client will receive message 2, message 5, and then message 6. This breaks message ordering, since the client is sending the messages to the server in the following incorrect order: message 1, message 3, message 4, message 2, message 5, and message 6.

Another problem can occur when the message engine is attached to multiple clients. If the message engines sends messages to whichever client requests messages, the messages may be sent out of order, depending on which order the clients happen to request the messages.

Another problem can occur if a client attaches to the message engine before a failed transaction fully recovers in-doubt transactions since the message engine will deliver the next visible message to the client and thus deliver messages out of order.

Without a better way to handle batch messages, multiple clients, and in-doubt transactions, message engines will be unable to ensure ordering of messages. Although the aforementioned problems have been described in the context of database transactions, they may occur in any type of transaction or application. Further although the clients and message engine have been described as if they exist on different computers attached via a network, some or all of them may be on the same computer.

### SUMMARY

A method, apparatus, system, and signal-bearing medium are provided that in an embodiment enforce ordering of messages sent from a queue to clients. If a total order indicator is on for a queue associated with a get message request, the next message is sent from the queue to the client if the queue does not have an associated in-doubt transaction. An in-doubt transaction may be a transaction for which the client has not received a commit request. In another embodiment, an authorized client is selected and messages are only sent from the queue to the authorized client.

### BRIEF DESCRIPTION OF THE DRAWING

FIG. 1 depicts a block diagram of an example system for implementing an embodiment of the invention.

FIG. 2 depicts a block diagram of an example queue data structure, according to an embodiment of the invention.

FIG. 3 depicts a flowchart of example processing for handling a request to turn a total order quality-of-service indicator on or off in a message engine, according to an embodiment of the invention.

FIG. 4 depicts a flowchart of example processing for handling a batch of messages at a client, according to an embodiment of the invention.

FIG. 5 depicts a flowchart of example processing for resending a batch of messages at a message engine, according to an embodiment of the invention.

FIG. 6 depicts a flowchart of example processing for handling a get message request at a message engine, according to an embodiment of the invention.

### DETAILED DESCRIPTION

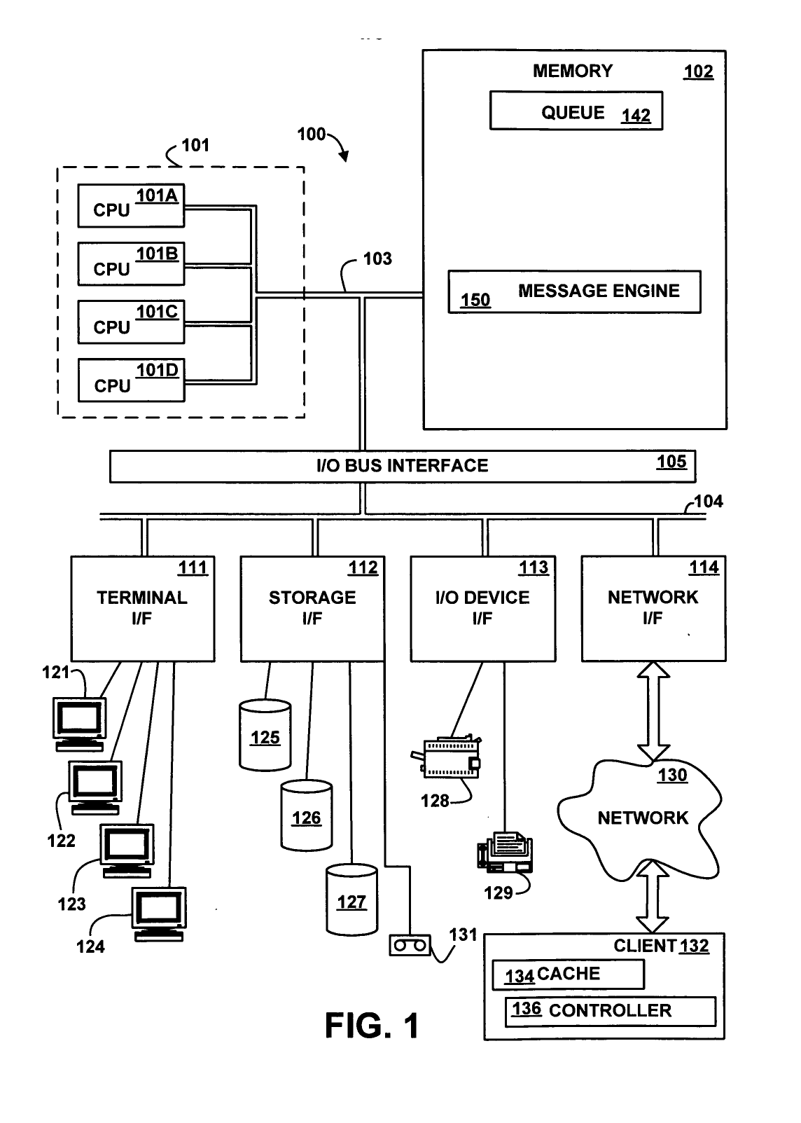

Referring to the Drawing, wherein like numbers denote like parts throughout the several views, FIG. 1 depicts a high-level block diagram representation of a computer system 100 connected to a client 132 via a network 130, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes a queue 142 and a message engine 150. Although the queue 142 and the message engine 150 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the queue 142 and the message engine 150 are illustrated as residing in the memory 102, these elements are not necessarily all completely contained in the same storage device at the same time.

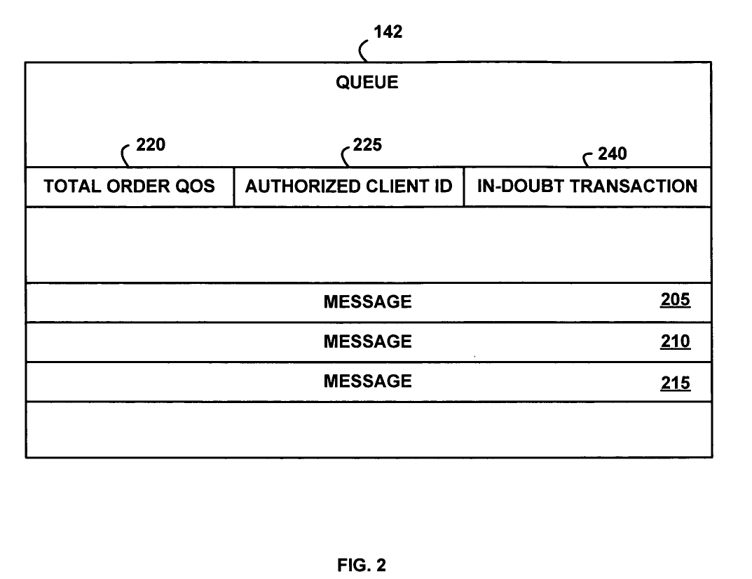

The queue 142 stores messages from the clients 132 that are intended for other of the clients 132. In an embodiment, the queue 142 is a FIFO (First In First Out) queue, but in other embodiments the message engine 150 may enforce any appropriate ordering of the queue 142. Although only one queue 142 is illustrated, in other embodiments any number of queues may be present. The queue 142 is further described below with reference to FIG. 2.

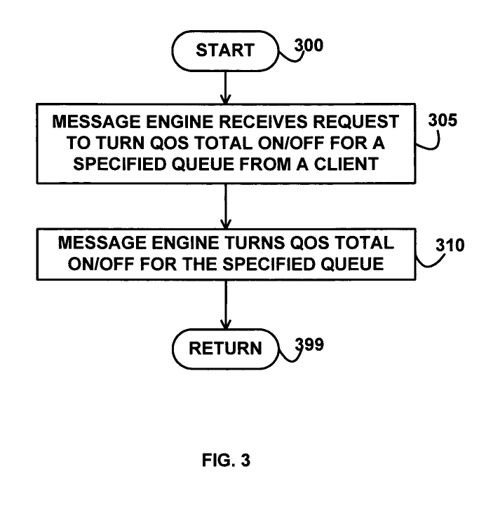

The message engine 150 manages the queue 142, receives messages from the clients 132, sends messages to the clients 132 from the queue 142, and receives and processes requests from the clients 132. In an embodiment, the message engine 150 includes instructions capable of executing on the processor 101 or statements capable of being interpreted by instructions executing on the processor 101 to perform the functions as further described below with reference to FIGS. 3, 5, and 6. In another embodiment, the message engine 150 may be implemented in microcode. In yet another embodiment, the message engine 150 may be implemented in hardware via logic gates and/or other appropriate hardware techniques, in lieu of or in addition to a processor-based system.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be loaded from and stored to the memory 102 as needed. The storage interface unit 112 may also support other types of devices, such as a tape device 131, an optical device, or any other type of storage device.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The client 132 includes a cache 134 and a controller 136, which sends messages to and receives messages from the computer system 100. The controller 136 stores messages in the cache 134. The client 132 may include some or all of the hardware components previously described above for the computer system 100. The controller 136 in the client 132 sends requests to the messaging engine 150. Examples of requests are get message (a request to retrieve a message from the queue 142) and put message (a request to add a message to the queue 142. The messages are intended for another of the clients 132, who listens on the queue 142 or otherwise issues get message requests to the queue 142. Thus, messages are a technique for the clients 132 to communicate with each other via the queue 142. But, the sender client does not designate the ultimate recipient; instead, all the sender can designate is which queue 142 (there may be multiple queues) the message engine 150 will post the message to. The recipient client selects which queue 142 to request messages from via the get message request. Although only one client 132 is illustrated, in other embodiments any number of clients may be present.

It should be understood that FIG. 1 is intended to depict the representative major components of the computer system 100 and the client 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127) or diskette; or
(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example data structure for the queue 142, according to an embodiment of the invention. The queue 142 includes message entries 205, 210, and 215, but in other embodiments any number of message entries may be present. The queue 142 includes a total order quality-of-service indicator 220, an authorized client identifier 225, and an in-doubt transaction indicator 240.

The total order quality-of-service indicator 220 indicates whether one of the clients 132 has requested that the message engine 150 send the messages on the queue 142 to a requesting client in absolute order. Absolute order means the message engine 150 sends the messages in order to the client 132, and the message engine 150 does not send the next message to the client 132 until the client 132 has processed the previous message. The order may be FIFO (First In First Out) or any other appropriate order.

The authorized client identifier 225 indicates the client 132 that is authorized to receive messages from the queue 142. If the total order quality-of-service indicator 220 is on, the message engine 150 chooses which client 132 (specified in the authorized client identifier 225) should receive the next message from the queue 142, one-at-a-time. So, for example, if two of the clients 132 request messages from the same queue 142 and the message engine 150 chooses the first client of the clients 132, then the message engine 150 does not send any messages to the second client of the clients 132 until the message engine 150 has sent all messages on the queue 142 to the first client.

The in-doubt transaction indicator 240 indicates whether in-doubt transactions are associated with the queue 142. An in-doubt transaction is a transaction for which the client 132 (which requests a message from the queue 142) has been prepared, but not committed or rolled back in a two-phase commit protocol.

FIG. 3 depicts a flowchart of example processing for handling a request to turn the total order quality-of-service indicator 220 on or off in the message engine 150, according to an embodiment of the invention. Control begins at block 300. Control then continues to block 305 where the message engine 150 receives a request from one of the clients 132 to turn the total order quality-of-service indicator 220 on or off for a specified queue 142. Control then continues to block 310 where the message engine 150 turns the total order quality-of-service indicator 220 on or off for the specified queue 142, depending on the request. Control then continues to block 399 where the logic of FIG. 3 returns.

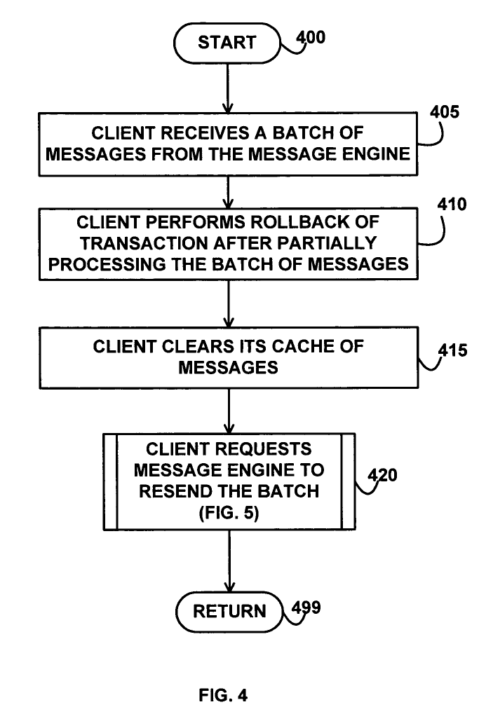

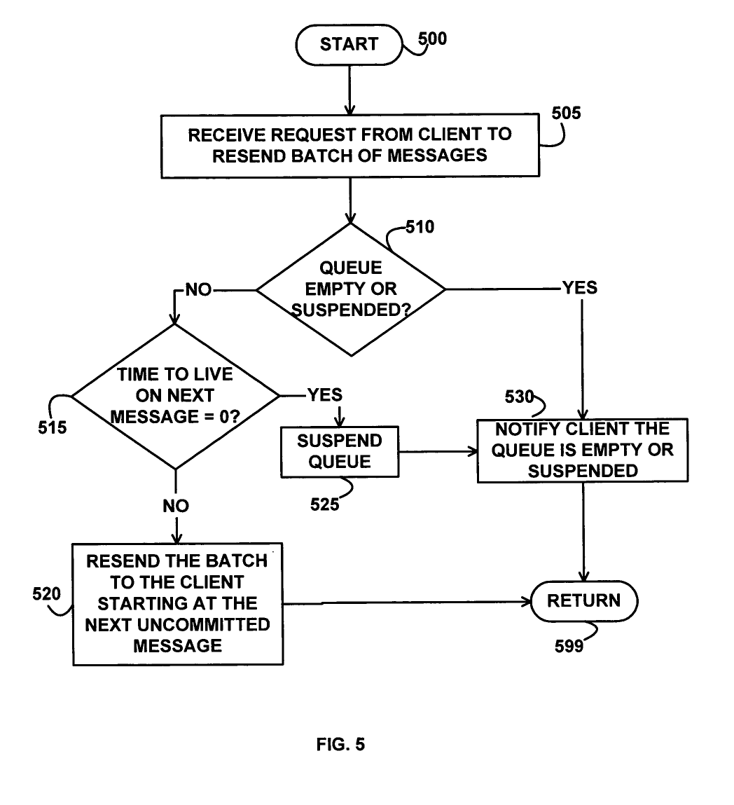

FIG. 4 depicts a flowchart of example processing for handling a batch of messages at the client 132, according to an embodiment of the invention. Control begins at block 400. Control then continues to block 405 where the controller 136 at the client 132 receives a batch of messages from the queue 142 via the message engine 150. Control then continues to block 410 where the controller 136 performs a rollback of transactions after partially processing the batch of messages. Control then continues to block 415 where the controller 136 clears the cache 134 of the messages. Control then continues to block 420 where the controller 136 sends a message to the message engine 150 requesting the message engine 150 to resend the batch of messages, as further described below with reference to FIG. 5. Control then continues to block 499 where the logic of FIG. 4 returns.

FIG. 5 depicts a flowchart of example processing for resending a batch of messages at the message engine 150, according to an embodiment of the invention. Control begins at block 500. Control then continues to block 505 where the message engine 150 receives the request from the controller 136 at the client 132 to resend the batch of messages (previously issued at block 420 of FIG. 4). Control then continues to block 510 where the message engine 150 determines whether the queue 142 is empty or suspended. If the determination at block 510 is true, then the queue 142 is empty or suspended, so control continues to block 530 where the message engine 150 informs the client 132 that the queue 142 is empty or suspended. Control then continues to block 599 where the logic of FIG. 5 returns.

If the determination at block 510 is false, then the queue 142 is not empty or suspended, so control continues to block 515 where the message engine 150 determines whether the time-to-live counter on the next message is zero. The time-to-live counter starts at a threshold value and is decremented each time that a rollback operation is executed. Thus, the time-to-live counter reaching zero indicates that the transaction to which the message belongs as been retried enough. If the determination at block 515 is true, then the time-to-live counter for the next message on the queue 142 is zero, so control continues to block 525 where the message engine 150 suspends the queue 142. Control then continues to block 530 where the message engine 150 notifies the requesting client 132 that the queue is suspended. In an embodiment, the notification gives a system administrator at the client 132 an opportunity to fix the problem with the queue 142 that has caused it to be empty or suspended. Control then continues to block 599 where the logic of FIG. 5 returns.

If the determination at block 515 is false, then the time-to-live counter for the next message on the queue 142 is not zero, so control continues to block 520 where the message engine resends the batch of messages from the queue 142, starting at the next uncommitted message on the queue to the requesting client 132. Control then continues to block 599 where the logic of FIG. 5 returns.

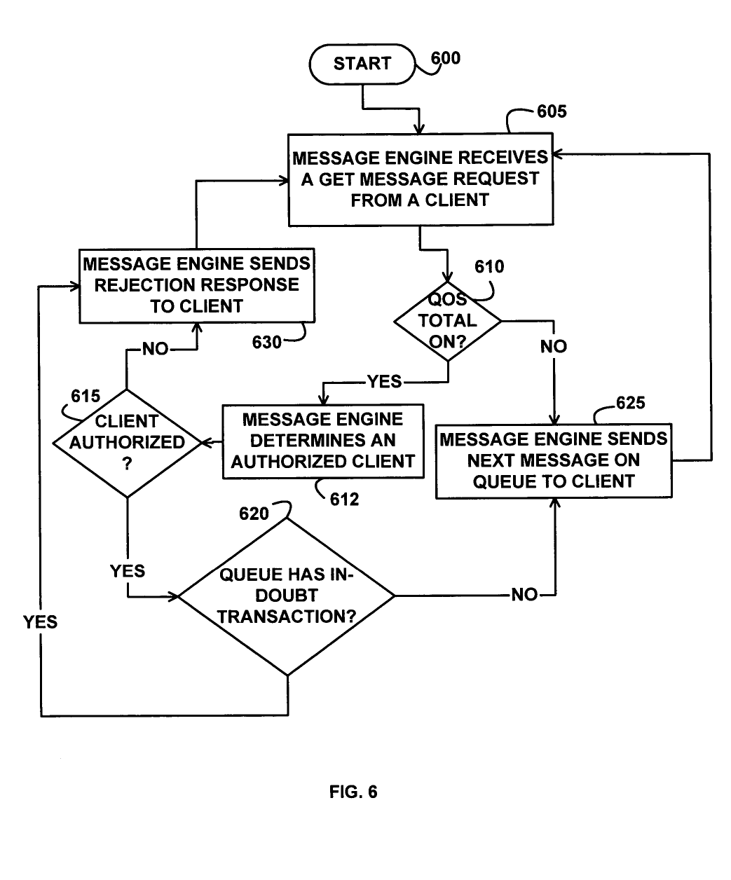

FIG. 6 depicts a flowchart of example processing for handling a get message request at the message engine 150, according to an embodiment of the invention. Control begins at block 600. Control then continues to block 605 where the message engine 150 receives a get message request from the client 132 that is directed to a specified queue 142 to which the get message request is directed. Control then continues to block 610 where the message engine 150 determines whether the total order quality-of-service indicator 220 is on in the specified queue 142.

If the determination at block 610 is true, then the total order quality-of-service indicator 220 is on in the queue 142 that is associated with the get message request, so control continues to block 612 where the message engine 150 selects or determines the client to receive messages from the specified queue 142. The message engine 150 stores an identifier of the determined client into the authorized client identifier field 225 in the specified queue 142. In various embodiments, the determination of the authorized client is based on priorities of the clients, based on a round-robin technique (one client after another, each in turn), or based on any other appropriate technique. Control then continues to block 615 where the message engine 150 determines whether the authorized client indicator 225 specifies the identifier of the client that sent the get message request (previously received at block 605). If the determination at block 615 is true, then the authorized client indicator 225 does specify the identifier of the client that sent the get message request, so control continues to block 620 where the message engine 150 determines whether the queue has an in-doubt transaction via the in-doubt transaction field 240.

If the determination at block 620 is true, then the queue has an associated in-doubt transaction, so control continues to block 630 where the message engine 150 sends a rejection response to the client that sent the get message request. Control then returns to block 605, as previously described above.

If the determination at block 620 is false, then the queue 142 does not have an in-doubt transaction, so control continues to block 625 where the message engine 150 sends the next message on the queue 142 to the client 132. Control then returns to block 605, as previously described above.

If the determination at block 615 is false, then the authorized client identifier 225 does not specify the identifier of the requesting client, so control continues to block 630 where the message engine 150 sends a rejection response to the requesting client 132. Control then returns to block 605, as previously described above.

If the determination at block 610 is false, then the total order quality-of-service indicator 220 is off in the queue 142 that is associated with the get message request, so control continues to block 625 where the message engine 150 sends the next message on the queue 142 to the requesting client 132. Control then returns to block 605, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

1. A method comprising:
receiving a get message request from a client;
determining whether a total order indicator is on for a queue associated with the get message request; and
if the determining is true, sending a next message from the queue to the client if the queue does not have an associated in-doubt transaction.

2. The method of claim 1, further comprising:
if the determining is true, sending the next message from the queue to the client if the client matches an authorized client.

3. The method of claim 2, further comprising:
selecting the authorized client from a plurality of clients.

4. The method of claim 1, further comprising.
resending a batch of messages to the client if the client cleared a cache containing the batch of messages.

5. An apparatus comprising:
means for receiving a get message request from a client;
means for determining whether a total order indicator is on for a queue associated with the get message request; and
means for sending a next message from the queue to the client if the queue does not have an associated in-doubt transaction if the determining is true, wherein the in-doubt transaction is a transaction for which the client has not received a commit request.

6. The apparatus of claim 5, further comprising:
means for sending the next message from the queue to the client if the client matches an authorized client if the means for determining is true.

7. The apparatus of claim 6, further comprising:
means for selecting the authorized client from a plurality of clients.

8. The apparatus of claim 5, further comprising:
means for resending a batch of messages to the client if the client cleared a cache containing the batch of messages.

9. A signal-bearing medium encoded with instructions, wherein the instructions when executed comprise:
receiving a get message request from a client;
determining whether a total order indicator is on for a queue associated with the get message request;
sending the next message from the queue to the client if the client matches an authorized client if the determining is true; and
sending a rejection notification to the client if the client does not match an authorized client if the determining is false.

10. The signal-bearing medium of claim 9, further comprising:
sending a next message from the queue to the client if the queue does not have an associated in-doubt transaction if the determining is true, wherein the in-doubt transaction is a transaction for which the client has not received a commit request.

11. The signal-bearing medium of claim 9, further comprising:
selecting the authorized client from a plurality of clients.

12. The signal-bearing medium of claim 9, further comprising:
resending a batch of messages to the client if the client cleared a cache containing the batch of messages.

13. A computer system comprising:
a processor; and
memory encoded with instructions, wherein the instructions when executed on the processor comprise:
receiving a get message request from a client,
determining whether a total order indicator is on for a queue associated with the get message request,
sending a next message from the queue to the client if the queue does not have an associated in-doubt transaction if the determining is true, wherein the in-doubt transaction is a transaction for which the client has not received a commit request,
sending the next message from the queue to the client if the client matches an authorized client if the determining is true, and
selecting the authorized client from a plurality of clients.

14. The computer system of claim 13, wherein the selecting further comprises:
selecting the authorized client via a round-robin technique from among the plurality of clients.

15. The computer system of claim 13, wherein the selecting further comprises:
selecting the authorized client via priorities of the plurality of clients.

16. The computer system of claim 13, wherein the instructions further comprise:
resending a batch of messages to the client if the client cleared a cache containing the batch of messages.

17. A method for configuring a computer, wherein the method comprises:
configuring the computer to receive a get message request from a client;
configuring the computer to determine whether a total order indicator is on for a queue associated with the get message request; and
configuring the computer to send a next message from the queue to the client if the queue does not have an associated in-doubt transaction if the determining is true.

18. The method of claim 17, further comprising:
configuring the computer to send the next message from the queue to the client if the client matches an authorized client if the determining is true.

19. The method of claim 18, further comprising:
configuring the computer to select the authorized client from a plurality of clients.

20. The method of claim 17, further comprising:
configuring the computer to resend a batch of messages to the client if the client cleared a cache containing the batch of messages.
